(19) United States
(12) Patent Application Publication
(10) Pub. No.: US 2007/0200797 A1
(43) Pub. Date: Aug. 30, 2007

(54) Filter and plasma display device using the same

(76) Inventors: Ji-Suk Kim, Suwon-si (KR); Sung-Yong Lee, Suwon-si (KR); Cha-Won Hwang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/711,123

(22) Filed: Feb. 27, 2007

(30) Foreign Application Priority Data
Feb. 28, 2006 (KR) 10-2006-0019492
Mar. 28, 2006 (KR) 10-2006-0028117

(51) Int. Cl. G09G 3/28

(52) U.S. Cl. 345/60

(57) ABSTRACT

A filter may include a base film and multiple color pattern units included in the base film. The filter may also include a front pattern layer containing multiple color pattern units, where widths of cross sections of the color pattern units may be greater in parts oriented toward a front of the front pattern layer than in parts oriented toward a rear of the front pattern layer, and a rear pattern layer may be on the rear side of the front pattern layer, and the rear pattern layer may include multiple color pattern units, where widths of cross sections of the color pattern units may be greater in parts oriented toward a rear of the rear pattern layer than in parts oriented toward a front of the rear pattern layer, and a plasma display panel using the filter.

### BACKGROUND OF THE INVENTION

1. Field of the Invention

The present invention relates to a filter and a display device including the filter and, more particularly, to a lightweight filter that reduces double image reflection and improves light-room contrast, and a plasma display device including the filter.

2. Description of the Related Art

Plasma display devices using a plasma display panel (PDP) display images by using a gas discharge phenomenon. PDP devices are regarded as the next-generation large-size flat panel display devices because they have superior brightness, contrast, residual image and viewing angle, compared to conventional cathode-ray tubes (CRTs). PDP devices may form images on thin large-screen displays.

However, in general PDP devices, images may be doubly reflected due to refraction arising from the different refractive indexes of a front substrate and a reinforced glass filter of the PDP. Another problem of general PDPs may stem from the thickness of the tempered glass being maintained to a certain magnitude, approximately 3 mm, to withstand exterior impacts, and the weight and expense of the PDPs are therefore increased.

### SUMMARY OF THE INVENTION

The present invention is therefore directed to a filter which substantially overcomes one or more of the problems due to the limitations and disadvantages of the related art.

It is therefore a feature of an embodiment of the present invention to provide a lightweight filter that reduces double image reflection and improves light-room contrast, and a plasma display device including the filter.

It is therefore a feature of an embodiment of the present invention to provide a filter which may be manufactured easily with less manufacturing costs and a plasma display device including the filter.

At least one of the above and other features and advantages of the present invention may be realized by providing a filter that may include a base film and multiple color pattern units included in the base film.

The vertical cross sections of the color pattern units may have a triangular or trapezoidal shape. A base width of the vertical cross sections of the color pattern units may be in a range of about 10 μm through about 200 μm. A ratio of a shorter parallel side width to a longer parallel side width of the vertical cross sections of the color pattern units may be less than 0.9 of a longer parallel side width when the vertical cross sections of the color pattern units are trapezoidally shaped. A light absorption reflection layer may be formed on the surface of the color pattern units. An anti-reflection layer containing a hard coating material may be on one side of the filter, and a hard coating layer may be on the anti-reflection layer. An electromagnetic shield layer may be on one side of the filter, and a near infrared shield layer may be on one side of the filter. A color correction layer may be on one side of the filter. An adhesive layer containing at least one pigment may be on one side of the base film. A plasma display device may include a plasma display panel, a driving circuit, a chassis which may support the plasma display panel and the driving circuit, and the filter may be on a front side of the plasma display panel.

At least one of the above and other features and advantages of the present invention may be realized by providing a filter that may include a front pattern layer composed of multiple first color pattern units, where widths of horizontal cross sections of the first color pattern units may be greater in parts oriented toward a front side of the front pattern layer than in parts oriented toward a rear side of the front pattern layer, and a rear pattern layer may be on the rear side of the front pattern layer, where the rear pattern layer may include multiple second color pattern units, wherein the widths of horizontal cross sections of the color pattern units may be greater in parts oriented toward a rear of the rear pattern layer than in parts oriented toward a front of the rear pattern layer, and the front of the rear pattern layer may on the rear of the front pattern layer.

The first color pattern units in the front pattern layer and the second color pattern units in the rear pattern layer may be arranged alternately. The vertical cross sections of the color pattern units in the front pattern layer and the rear pattern layer may have a triangular or trapezoidal shape, and a slope of the vertical cross sections of the first color pattern units in the front pattern layer and a slope of the vertical sections of the second color pattern units in the rear pattern layer may be substantially the same. A base width of the vertical cross sections, when the vertical cross sections are triangular shaped, or a longer parallel side of the vertical cross sections, when the vertical cross sections are trapezoidally shaped, of the first and second color pattern units in the front pattern layer and the rear pattern layer may be in a range of about 10 μm through about 100 μm, and a height of the first color pattern units in the front pattern layer and the second color pattern units in the rear pattern layer may be in a range of about 10 μm through about 500 μm. A ratio of a shorter parallel side to a longer parallel side of the vertical cross sections of the first and second color pattern units may be less than about 0.9 when the vertical cross sections of the first and second color pattern units are trapezoidally shaped. An anti-reflection layer containing a hard coating material may be on one side of the filter, and a hard coating layer may be on the anti-reflection layer. An electromagnetic shield layer may be on one side of the filter, and a near infrared shield layer may be on one side of the filter. A color correction layer may be on one side of the filter. An adhesive layer containing at least one pigment may be on one side of the filter. A plasma display device may include a plasma display panel, a driving circuit, a chassis which may support the plasma display panel and the driving circuit, and the filter may be on a front side of the plasma display panel.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial sectional view of the composition of a filter according to an embodiment of the present invention;

FIG. 2 illustrates a partial sectional view of the composition of a filter according to another embodiment of the present invention;

FIG. 3 illustrates a partial sectional view of the composition of a filter according to another embodiment of the present invention;

FIG. 4 illustrates a partial sectional view of the composition of a filter according to another embodiment of the present invention;

FIG. 5 illustrates a perspective view of a plasma display device including the filter illustrated in FIG. 1, according to an embodiment of the present invention; and

FIG. 6 illustrates a cross-sectional view of the plasma display device of FIG. 5 taken along a line VI-VI′ in FIG. 5, according to an embodiment of the present invention.

### DETAILED DESCRIPTION OF THE INVENTION

Korean Patent Applications No. 10-2006-0019492, filed on Feb. 28, 2006, and No. 10-2006-0028117, filed on Mar. 28, 2006, in the Korean Intellectual Property Office, both entitled: “Filter and Plasma Display Device Using the Same,” are incorporated by reference herein in their entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it may be directly on the other layer or substrate, or intervening layers may also be present. Further, it will be understood that when a layer is referred to as being “under” another layer, it may be directly under, and one or more intervening layers may also be present. In addition, it will also be understood that when a layer is referred to as being “between” two layers, it may be the only layer between the two layers, or one or more intervening layers may also be present. Like reference numerals refer to like elements throughout.

The present invention will now be described more fully with reference to the accompanying drawings, in which exemplary embodiments of the invention are shown.

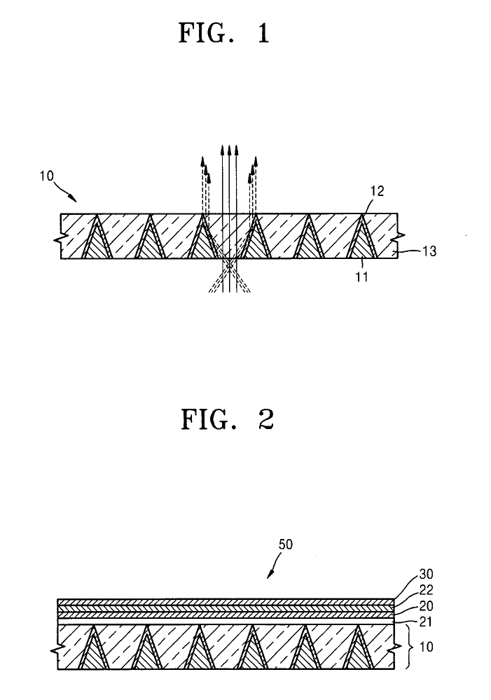

FIG. 1 illustrates a partial sectional view of a filter 10 according to an embodiment of the present invention.

Referring to FIG. 1, the filter 10 may include a color pattern unit 11 and a base film 13.

The color pattern unit 11 may have a vertical cross section having, e.g., a triangular shape, a trapezoidal shape, etc. The width of a horizontal cross-section of the color pattern unit 11 oriented toward the front of the filter 10 may be less than the width of a horizontal cross section of the color pattern unit 11 oriented toward the rear of the filter 10. The color pattern unit 11 may be formed of a material having high visible light absorptivity, and the color pattern unit 11 may be of a color having low brightness and saturation, e.g., black. The surface of the color pattern unit 11 may be coated with a light absorption reflection layer 12. A light absorption reflection layer 12 may be formed of a material having high reflectivity to visible light and may be formed of at least one metal selected from, e.g., Ag, Ni, Cu, Cr, etc.

The base width, in the case of a triangular vertical cross section, or the longer parallel side, in the case of a trapezoidally shaped vertical cross section, of the color pattern unit 11 may be in the range of about 10.0 μm to about 200.0 μm. This width range may be suitable to maximize light-room contrast by light interception, transmission and diffusion of visible light, when the width of a discharge cell in a plasma display panel using the filter 10 may be about 600 μm. When the vertical cross section of the color pattern unit 11 is a trapezoid, the longer parallel side of the trapezoid may be in the range of about 10.0 μm to about 200.0 μm, and the ratio of the shorter parallel side of the trapezoid to the longer parallel side of the trapezoid may be less than about 0.9.

Multiple color pattern units 11 may be in the base film 13. The color pattern units 11 may be distributed evenly with substantially the same distance between one another. The color pattern units may also be distributed unevenly.

The base film 13 may be formed of a flexible, visible-light permeable material for ease of transportation and bonding.

The base film 13 may be formed of at least one of, e.g., polyethersulphone (PES), polyacrylate (PAR), polyetherimide (PEI), polyethylene naphthalate (PEN), polyethyleneterephthalate (PET), polyphenylene sulfide (PPS), polyallylate, polyimide, polycarbonate (PC), cellulose tri-acetate (TAC), cellulose acetate propionate (CAP), etc. The base film 13 may preferably may be formed of, e.g., PC, PET, TAC, or PEN.

The base film 13 may be dyed or pigmented to have a predetermined color. Thus, the visible-light permeability of the entire filter 10 may be adjusted by controlling the dying or pigmenting conditions of the base film 13. The visible-light permeability of the filter 10 may be decreased by forming the base film 13 to have a dark color. In addition, the color of visible light projected forward may be controlled. The base film 13 may be wholly dyed or pigmented to have a color with which users feel visually comfortable, or to have an improved color purity of a display device using the filter 10. Also, the base film 13 may be patterned with color pixels which correspond to sub-pixels of a plasma display panel using the filter 10. The color pixels may be red (R), green (G), or blue (B) pixels. However, the present invention is not limited thereto, and the base film 13 may be dyed or pigmented using various methods for various color corrections.

The base film 13 may have a flat panel form, and the thickness thereof may be about 50 μm through about 500 μm. Since the anti-scattering effect in case of panel breakage may decrease as the thickness of the base film 13 is reduced, while the efficiency of a laminating process of forming the base film 13 may decrease as the thickness is increased, the thickness of the base film 13 may be, e.g., about 80 μm through about 400 μm.

The filter 10 may transmit visible light perpendicularly incident to the back of the base film 13 to the front of the base film 13, while the color pattern unit 11 intercepts a portion of visible light as illustrated by the arrows in FIG. 1. The diffused visible light may be reflected by the light absorption reflection layer 12 to be emitted perpendicularly from the filter 10 to the base film 13. In display devices which have more diffused light than straight light, such as plasma display panels, the clarity of images may be improved by using the filter 10 to focus visible light forward, i.e., toward the front. Further, visible light which is projected from the front may not be reflected toward the front, but may be dispersed toward the back by the light absorption reflection layer 12. Thus, the filter 10 may sharply increase the light-room contrast without decreasing the quantity of the visible light transmitted from the rear side of the filter 10 to the front side of the filter 10.

FIG. 2 illustrates a partial sectional view schematically depicting a filter structure 50 according to another embodiment of the present invention.

Referring to FIG. 2, the filter structure 50 may include an electromagnetic wave shield layer 20 and an anti-reflection layer 30 on one surface of a filter 10, which may be similar to the filter 10 illustrated in FIG. 1. The filter 10 may include a color pattern unit 11, a light absorption reflection layer 12, and a base film 13. The electromagnetic wave shield layer 20 and the anti-reflection layer 30 may be bonded onto the front of the color pattern unit 11, as illustrated in FIG. 2, or alternatively to the back of the color pattern unit 11.

The electromagnetic wave shield layer 20 may shield electromagnetic waves, which may be harmful to humans, which may be generated by display devices using the filter structure 50. The electromagnetic wave shield layer 20 may be formed by laminating at least one metal layer or metal oxide layer on or below the filter 10. The electromagnetic wave shield layer 20 may have a multi-layer structure of, e.g., about five to about eleven layers. Depositing metal oxide layers together with metal layers may prevent the metal layers from oxidizing or deteriorating. Further, forming the electromagnetic wave shield layer 20 to have a multi-layer structure may not only reduce the surface resistance of the electromagnetic wave shield layer 20, but also may adjust visible-light permeability.

The metal layer may composed of layers or composites of at least one of, e.g., palladium (Pd), copper (Cu), platinum (Pt), rhodium (Rh), aluminum (Al), iron (Fe), cobalt (Co), nickel (Ni), zinc (Zn), ruthenium (Ru), tin (Sn), tungsten (W), iridium (Ir), lead (Pb), silver (Ag), etc. The metal oxide layer may be formed of at least one of, e.g., tin oxide, indium oxide, antimony oxide, zinc oxide, zirconium oxide, titanium oxide, magnesium oxide, silicon oxide, aluminum oxide, metal alkoxide, indium tin oxide, antimony tin oxide, etc.

The electromagnetic wave shield layer 20 may be formed on a film layer 21 using, e.g., sputtering, vacuum deposition, ion plating, CVD, PVD, etc., after forming the film layer 21 on or below the surface of the filter 10.

The metal layer or metal oxide layer may shield not only electromagnetic waves, but also near infrared rays. Thus, malfunctioning of ambient electric devices due to near infrared rays may be reduced.

The electromagnetic wave shield layer 20 is not limited to those described above and may be formed in a mesh form using a conductive metal. The conductive metal may be at least one of, e.g., Cu, Al, etc.

The anti-reflection layer 30 may disperse external incident light on its surface and may prevent external incident light of the filter 10 from reflecting from the surface of the filter 10. Since the formation of an anti-reflection layer 30 on a conventional tempered glass filter may result in a sharp decrease in image clarity due to the gap between a front substrate and the tempered glass filter, the anti-reflection layer 30 may not be applied to a conventional tempered glass filter. Since the filter structure 50 according to the current embodiment of the present invention may be attached directly to the front surface of display panels, the image clarity may rarely decrease, and thus the anti-reflection layer 30 may be used in the filter structure 50.

The filter structure 50 may include a hard coating material (not shown) inside the anti-reflection layer 30. Display devices using the filter structure 50 may receive various types of external forces during operation, and thus may be scratched as a result of these external forces. The scratches resulting from external forces may be prevented by including the hard coating material inside the anti-reflection layer 30. Alternatively, a hard coating layer may be formed on the anti reflection layer 30. The hard coating layer may be used in conjunction with adding a hard coating material to the anti-reflection layer 30. The hard coating material may include a polymer as a binder. The binder material may be at least one of, e.g., acrylic polymer, methacrylic polymer, urethane polymer, epoxy polymer, siloxane polymer, ultraviolet curable resin, etc. Oligomeric materials may also be used. A filler, e.g., silica, may be included to improve hardness.

The thickness of the anti-reflection layer 30 may be about 2.0 μm through about 7.0 μm. The antireflection layer 30 may have a hardness of about 2 through about 3H. The antireflection layer 30 may have a haze of about 1.0% through about 3.0%. However, the present invention is not limited to these parameters.

An adhesive layer 22 may be between the electromagnetic wave shield layer 20 and the anti-reflection layer 30. The adhesive layer 22 may improve adhesive force between the electromagnetic wave shield layer 20 and the anti-reflection layer 30. Another adhesive layer (not shown) may also be on the lower surface of the filter 10 to ensure adhesion to the front of the display panel. The difference in refractive index of the adhesive layer 22 from that of the display panel may be smaller than a predetermined value, e.g., about 1.0%, to reduce double reflection.

The adhesive layer 22 may include a thermoplastic UV-curable resin, e.g., acrylate resin, methacrylate resin, pressure-sensitive adhesive (PSA), etc. The adhesive layer 22 may be formed using, e.g., a dip coating method, an air knife method, a roller coating method, a wire-bar coating method, a gravure coating method, etc.

The adhesive layer 22 may further include a compound which absorbs near infrared rays. The compound capable of absorbing infrared rays may include, e.g., a resin containing copper atoms, a resin containing copper compounds or phosphor compounds, a resin containing copper compounds and/or thiourea derivatives, a resin containing tungsten compounds, cyanine compounds, etc.

In addition, the adhesive layer 22 may further include dyes or pigments, e.g., a dye for correcting colors by intercepting neon light. The dyes or pigments may selectively absorb light in the wavelength range of about 400 nm through about 700 nm, i.e., in the visible light region. Unnecessary visible light in the vicinity of a wavelength of approximately 585 nm may be generated (or emitted) by neon gas, which may be used as a discharge gas, during the discharge of a plasma display panel. To absorb such visible light, the adhesive layer 22 may contain at least one compound that may be, e.g., a cyanine compound, a squaryl compound, an azomethine compound, a xanthene compound, an oxonol compound, an azo compound, etc. These dyes or pigments may be in particulate form and may be included in the adhesive layer 22 as a dispersion.

The filter structure 50 may further include a near infrared ray shield layer (not shown) and/or a color correction layer (not shown). Near infrared rays may be shielded by the electromagnetic wave shield layer 20 or the adhesive layer 22, but an additional layer may be formed to improve the near infrared ray shield function, when necessary. The color correction layer may be used when it is advantageous to correct color purity or color temperature of the visible light incident from the display device using the filter structure 50.

The light permeability of the filter structure 50 may be in the range of, e.g., about 30.0% through about 80.0%. Also, the filter structure 50 may have a haze of, e.g., about 1.0% through 10.0%.

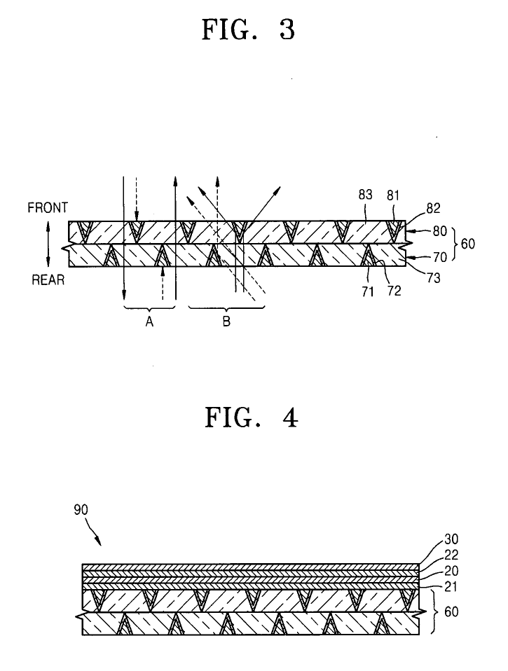

FIG. 3 illustrates a partial cross-sectional view of a filter 60 according to another embodiment of the present invention.

Referring to FIG. 3, the filter 60 may include a front pattern layer 80 and a rear pattern layer 70.

The front pattern layer 80 may include multiple front color pattern units 81 in a base film 83. The rear pattern layer 70 may include multiple rear color pattern units 71 in a base film 73. Here, the front or rear may be determined based on the display device using the filter 60.

The front color pattern units 81 may have a vertical cross section having, e.g., an inverted trapezoidal shape, an inverted triangular shape, etc., as illustrated in FIG. 3. The rear color pattern units 71 also may have a vertical cross section having, e.g., a trapezoidal or a triangular shape, etc., as illustrated in FIG. 3. The front color pattern units 81 and the rear color pattern units 71 may be respectively disposed in the base films 83 and 73. The front color pattern units 81 and the rear color pattern units 71 may be disposed horizontally in the filter 60. The front and rear color pattern units 81 and 71 may be formed of at least one material having high absorptivity to visible light and color of low saturation and brightness, e.g., black.

The shape and dimension of the front color pattern unit 81 and the rear color pattern unit 71 may be either the same or different, but the slope of the vertical cross sections thereof may be substantially the same. The base widths, in the case of triangular vertical cross sections, or longer parallel sides, in the case of trapezoidally shaped vertical cross sections, of the front color pattern units 81 and the rear color pattern units 71 may be in a range of about 10.0 μm through about 100.0 μm, since this range may be suitable for optimizing light-room contrast by intercepting, transmitting and diffusing light, considering that the length of discharge cells in a plasma display panel using the filter 60 may be approximately 600 μm. When the vertical cross sections of the front color pattern unit 81 and the rear color pattern unit 71 are trapezoidally shaped, the width of the longer parallel side of the trapezoid may be in the range of about 10.0 μm through about 100.0 μm, and the ratio of the shorter parallel side width to the longer parallel side width may be equal to or less than about 0.9. The height of the vertical cross sections of the front color pattern unit 81 and the rear color pattern unit 71 may be equal to or greater than about 10.0 μm, and may be as much as the thickness of the base films 83 and 73.

The front color pattern units 81 and the rear color pattern units 71 may be in the base films 83 and 73, respectively. The front and rear color pattern units 81 and 71 may respectively be substantially the same distance apart from one another.

Light absorption reflection layers 82 and 72 may be respectively formed on sides of the color pattern units 81 and 71. The light absorption reflection layers 82 and 72 may reflect visible light. The light absorption reflection layers 82 and 72 may be formed of at least one metal selected from, e.g., Ag, Ni, Cr, Cu, etc.

The base films 83 and 73 may be formed of a material that transmits visible light and may attach the filter 60 directly to a front side of a display device. Any material having an interfacial property favorable for attaching to the display panel, e.g., glass, plastic, etc., may be used to form the base films 83 and 73. The base films 83 and 73 may be formed of a flexible material for ease of transportation and subsequent attaching processes.

The base films 83 and 73 may be similar to the base film 13 of the filter 10 illustrated in FIG. 1, and thus a detailed description thereof is omitted. The base films 83 and 73 may be patterned with color pixels which correspond to sub-pixels of a plasma display panel using the filter 60. The color pixels may be red (R), green (G), or blue (B) pixels. However, the present invention is not limited thereto, and the base films 83 and 73 may be dyed using various methods for various color corrections.

The base films 83 and 73 may have a flat panel shape, and the thickness of each of the base films 83 and 73 may be about 50 μm through about 500 μm. However, as the thickness of the base films 83 and 73 is reduced, the anti-scattering effect may decreases in case of panel breakage. On the other hand, as the thickness of the base films 83 and 73 increases, the efficiency of laminating process may decrease. Therefore, the thickness of each of the base films 83 and 73 may be preferably about 80 μm through about 400 μm.

The filter 60 having the structure described above may be manufactured by fabricating two pattern layers 70 and 80 using, e.g., thermal imaging, and bonding one as a front pattern layer 80 to the other as a rear pattern layer 70 using, e.g., an adhesive agent. When bonding the two pattern layers, it may be advantageous to arrange the color pattern units in each layer alternately.

The filter 60 may intercept a portion of the visible light A that comes from the front or the rear side of the base films 83 and 73. Visible light A may be incident substantially perpendicular to the surface of the filter 60, as illustrated in FIG. 3 with arrows. Visible light B may not be incident perpendicular to the surface of the filter 60, to be reflected by the light absorption reflection layers 82 and 72, but may nonetheless be emitted from the filter 60 in a substantially perpendicular direction. Therefore, the filter 60 may improve visible light permeability and light-room contrast when used in display devices. In addition, most of the visible light that comes from the front side of the filter 60 may be absorbed by black beads and the front color pattern units 81 and the rear color pattern units 71, and thus light reflection may be sharply diminished to improve the light-room contrast. Also, anti-reflection function may be improved since reflection on the surface decreases.

FIG. 4 illustrates a partial cross-sectional view schematically depicting a filter structure 90 according to another embodiment of the present invention.

Referring to FIG. 4, the filter structure 90 may include an electromagnetic wave shield layer 20 and an anti-reflection layer 30 on one side of a filter 60, similar to the filter 60 illustrated in FIG. 3. The electromagnetic wave shield layer 20 and the anti-reflection layer 30 may be attached to a front side of the filter 60, as illustrated in FIG. 4, but may also be attached to a rear side thereof. The electromagnetic wave shield layer 20 and the anti-reflection layer 30 may be substantially the same as those of the filter structure 50 illustrated in FIG. 2, and thus a detailed description thereof is omitted.

An adhesive layer 22 may be between the electromagnetic wave shield layer 20 and the anti-reflection layer 30. The adhesive layer 22 may improve adhesive force between the electromagnetic wave shield layer 20 and the anti-reflection layer 30. Additionally, another adhesive layer (not shown) may be formed on the lower surface of the filter structure 90 to ensure adhesion to a front of a display panel. The difference in refractive index of the adhesive layer 22 from that of the display panel may be smaller than a predetermined value, e.g., about 1.0%, to reduce double image reflection.

The adhesive layer 22 may include a thermoplastic UV-curable resin, e.g., acrylate resin, methacrylate resin, pressure-sensitive adhesive (PSA), etc. The adhesive layer 22 may be formed using, e.g., a dip coating method, an air knife method, a roller coating method, a wire-bar coating method, a gravure coating method, etc.

The adhesive layer 22 may include a compound that absorbs near infrared rays. The compound capable of absorbing infrared rays may include, e.g., a resin containing copper atoms, a resin containing copper compounds or phosphor compounds, a resin containing copper compounds and/or thiourea derivatives, a resin containing tungsten compounds, cyanine compounds, etc.

The adhesive layer 22 may further include dyes or pigments for correcting colors by intercepting neon light. The dyes or pigments may selectively absorb light in the wavelength range of about 400 nm through about 700 nm, i.e., the visible light region. Unnecessary visible light in the vicinity of wavelength of approximately 585 nm may be generated (or emitted) by neon gas, which may be used as a discharge gas, during a discharge in a plasma display panel. To absorb this visible light, the adhesive layer 22 may contain at least one compound that may be, e.g., a cyanine compound, a squaryl compound, an azomethine compound, a xanthene compound, an oxonol compound, an azo compound, etc. These dyes or pigments may be in particulate form and may be included in the adhesive layer 22 as a dispersion.

The filter structure 90 may include a near infrared ray shield layer (not shown) and/or a color correction layer (not shown). Near infrared rays may be shielded by the electromagnetic wave shield layer 20 or the adhesive layer 22, but an additional layer may be formed to improve the near infrared ray shield function, when necessary. The color correction layer may be used when it is advantageous to correct color purity or color temperature of the visible light incident from a display device using the filter structure 90.

The light permeability of the filter structure 90 having the structure as described above may be, e.g., about 30.0% through about 80.0%. In addition, the filter structure 90 may have a haze of, e.g., about 1% through about 10%, preferably smaller than about 5.0%.

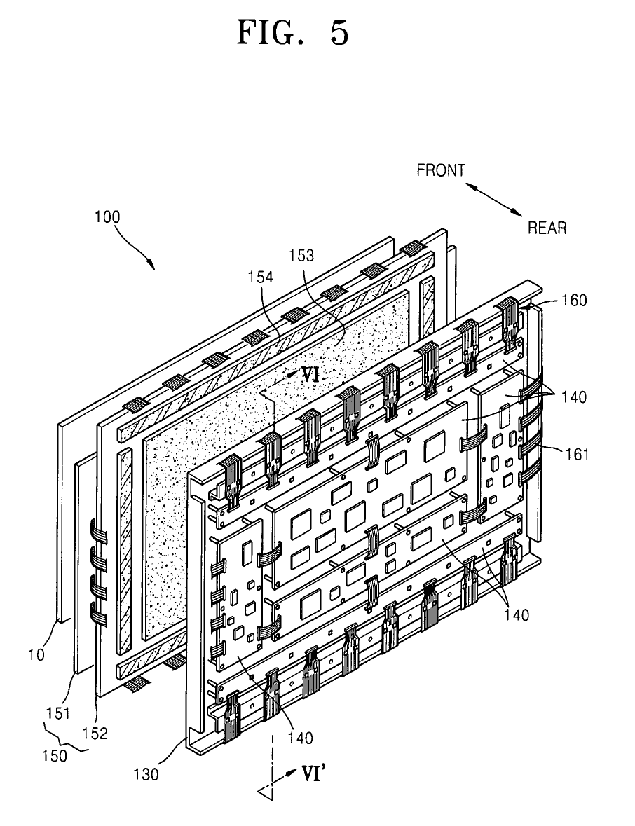

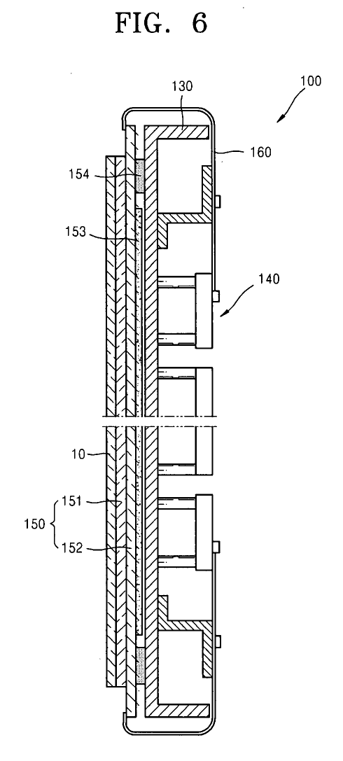

FIG. 5 illustrates a plasma display device 100 including the filter 10 illustrated in FIG. 1, according to an embodiment of the present invention. FIG. 6 illustrates a cross-sectional view of the plasma display device 100 taken along a line VI-VI′ of FIG. 5.

The plasma display device 100 may include a plasma display panel 150, a chassis 130 and a circuit unit 140. A filter 10 may be attached to the front side of the plasma display panel 150. Adhesive, e.g., double-sided tape 154, may be used to attach the plasma display panel 150 to the chassis 130. A heat-conducting supportive material 153 may be between the chassis 130 and the plasma display panel 150 to dissipate heat generated by the plasma display panel 150 during operation.

The plasma display panel 150 displays images using gas discharge, and the plasma display panel 150 may include a front panel 151 and a rear panel 152, which may be combined with each other.

The filter 10 may be attached to the front side of the plasma display panel 150 by an adhesive layer (not shown). However, the present invention is not limited thereto, and various filters, including the filter structure 50 illustrated in FIG. 2, may be used.

The filter 10 intercepts electromagnetic waves from the plasma display panel 150 and reduces glare. In addition, infrared rays or neon light may be intercepted. Further, double reflection problems may be fundamentally overcome because the filter 10 may be substantially directly attached to the front side of the plasma display panel 150.

Additionally, the weight and the costs of the plasma display device 100 may be decreased compared to a plasma display device including a conventional tempered glass filter.

The chassis 130 may be on the rear side of the plasma display panel 150 to structurally support the plasma display panel 150. The chassis 130 may be formed of a hard metal, e.g., Al, Fe, etc., or may be formed of plastics.

Heat-conducting supportive material 153 may be between the plasma display panel 150 and the chassis 130. Double sided tape 154 may be around the heat-conducting supportive material 153. The double-sided tape 154 may fix the plasma display panel 150 to the chassis 130.

The circuit unit 140 may be disposed on a rear side of the chassis 130 and may include a circuit which drives the plasma display panel 150. The circuit unit 140 may transmit electric signals to the plasma display panel 150 via signal transmission units. Flexible Printed Circuit (FPC), Tape Carrier Package (TCP), Chip On Film (COF), etc, may be used as the signal transmission units. As illustrated in FIG. 5, FPCs 161 may be at left and right sides of the chassis 130 as signal transmission units, and TCPs 160 may be at upper and lower sides of the chassis 130 as signal transmission units.

The filter according to the present invention may be attached to plasma display devices as has been described above. However the filter according to the present invention may also be attached to the front side of various display devices.

The filter and the plasma display device including the same according to the present invention may reduce double reflection since the filter may be directly attached to the front side of a display panel of the plasma display device, and may have improved (visible light) permeability and reduced weight because the filter may be manufactured using a relatively thin base film. In particular, the filter may include multiple color pattern units which are evenly distributed in the filter. Therefore, brightness may be increased due to the diffusion of internal light and external light interception may be improved, and thus bright-room contrast may be largely improved. Also, manufacturing costs may be reduced due to the simple manufacturing process.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A filter, comprising:
a base film; and
a plurality of color pattern units included in the base film.

2. The filter as claimed in claim 1, wherein vertical cross sections of the color pattern units have a triangular or trapezoidal shape.

3. The filter as claimed in claim 2, wherein a base width of the vertical cross sections of the color pattern units is in a range of about 10 μm through about 200 μm.

4. The filter as claimed in claim 2, wherein a ratio of a shorter parallel side width to a longer parallel side width of the vertical cross sections of the color pattern units is less than about 0.9 of a longer parallel side width, when the vertical cross sections of the color pattern units are trapezoidally shaped.

5. The filter of claim 1, wherein a light absorption reflection layer is formed on a surface of the color pattern units.

6. The filter of claim 1, further comprising an anti-reflection layer on one side of the filter.

7. The filter of claim 6, wherein the anti-reflection layer contains a hard coating material to prevent scratches due to external force.

8. The filter of claim 6, further comprising a hard coating layer on the anti-reflection layer.

9. The filter as claimed in claim 1, wherein an electromagnetic shield layer is on one side of the filter, and a near infrared shield layer is on one side of the filter.

10. The filter as claimed in claim 1, wherein a color correction layer is on one side of the filter.

11. The filter as claimed in claim 1, wherein an adhesive layer containing at least one pigment is on one side of the base film.

12. A plasma display device, comprising:
a plasma display panel;
a driving circuit;
a chassis which supports the plasma display panel and the driving circuit; and
the filter according to claim 1 on a front side of the plasma display panel.

13. A filter, comprising:
a front pattern layer composed of a plurality of first color pattern units, widths of horizontal cross sections of the first color pattern units being greater in parts oriented toward a front side of the front pattern layer than in parts oriented toward a rear side of the front pattern layer; and
a rear pattern layer on the rear side of the front pattern layer, the rear pattern layer being composed of a plurality of second color pattern units, wherein widths of horizontal cross sections of the second color pattern units are greater in parts oriented toward a rear of the rear pattern layer than in parts oriented toward a front of the rear pattern layer, and the front of the rear pattern layer is on the rear of the front pattern layer.

14. The filter as claimed in claim 13, wherein the first color pattern units in the front pattern layer and the second color pattern units in the rear pattern layer are arranged alternately.

15. The filter as claimed in claim 13, wherein vertical cross sections of the first and second color pattern units in the front pattern layer and the rear pattern layer have a triangular or trapezoidal shape, and a slope of the vertical cross sections of the first color pattern units in the front pattern layer and a slope of the vertical sections of the second color pattern units in the rear pattern layer are substantially the same.

16. The filter of claim 15, wherein a base width of the vertical cross sections when the vertical cross sections are triangular shaped and a longer parallel side of the vertical cross sections when the vertical cross sections are trapezoidally shaped of the color pattern units in the front pattern layer and the rear pattern layer is in the range of about 10 μm through about 100 μm.

17. The filter of claim 15, wherein a height of the color pattern units in the front pattern layer and the rear pattern layer is in the range of about 10 μm through about 500 μm.

18. The filter as claimed in claim 15, wherein a ratio of a shorter parallel side to a longer parallel side of the vertical cross sections of the first and second color pattern units is less than about 0.9 when the vertical cross sections of the first and second color pattern units are trapezoidally shaped.

19. The filter of claim 13 further comprising an anti-reflection layer on one side of the filter.

20. The filter of claim 19, wherein the anti-reflection layer contains a hard coating material to prevent scratches due to external force.

21. The filter of claim 19, further comprising a hard coating layer on the anti-reflection layer.

22. The filter as claimed in claim 13, wherein an electromagnetic shield layer is on one side of the filter, and a near infrared shield layer is on one side of the filter.

23. The filter as claimed in claim 13, wherein a color correction layer is on one side of the filter.

24. The filter as claimed in claim 13, wherein an adhesive layer containing at least one pigment is on one side of the filter.

25. A plasma display device, comprising:
a plasma display panel;
a driving circuit;
a chassis which supports the plasma display panel and the driving circuit; and
the filter according to claim 13 on a front side of the plasma display panel.
